(19) United States
(12) Patent Application Publication
(10) Pub. No.: US 2012/0213118 A1
(43) Pub. Date: Aug. 23, 2012

(54) METHOD AND SYSTEM FOR NETWORK INTERFACE CONTROLLER (NIC) ADDRESS RESOLUTION PROTOCOL (ARP) BATCHING

(76) Inventors: Steven B. Lindsay, Bend, OR (US); Hoan Do, Irvine, CA (US)

(21) Appl. No.: 13/095,534

(22) Filed: Apr. 27, 2011

Related U.S. Application Data
(60) Provisional application No. 61/444,648, filed on Feb. 18, 2011.

(51) Int. Cl. H04L 12/28

(52) U.S. Cl. 370/254

(57) ABSTRACT

A NIC of a host system may provide batching services to enable reducing and/or optimizing overall system power consumption. Batching servicing may comprise buffering received packet within the NIC for an extended period of time—longer than buffering time during normal handling of received packets—based on determination that delaying handling of the received packet by the host system is permitted. Delaying handling of received packets may enable at least one component of the host system, such as a processor, utilized during that handling to remain in power saving states. The received packet may comprise a broadcast ARP packet that does not require a response from the host system. Packets buffered in the NIC may be forwarded to the host system when one or more flushing conditions occur. Flushing conditions may comprise reception of unicast packets destined for the host system or broadcast packets requiring response from the host system.

### CLAIM OF PRIORITY

This patent application makes reference to, claims priority to and claims benefit from U.S. Provisional Application Ser. No. 61/444,648 (Attorney Docket No. 23649US01) which was filed on Feb. 18, 2011.

The above stated application is hereby incorporated herein by reference in its entirety.

### CROSS-REFERENCE TO RELATED APPLICATIONS/INCORPORATION BY REFERENCE

[Not Applicable].

### FEDERALLY SPONSORED RESEARCH OR DEVELOPMENT

[Not Applicable].

### [MICROFICHE/COPYRIGHT REFERENCE]

[Not Applicable].

### FIELD OF THE INVENTION

Certain embodiments of the invention relate to networked devices. More specifically, certain embodiments of the invention relate to a method and system for network interface controller (NIC) address resolution protocol (ARP) batching.

### BACKGROUND OF THE INVENTION

Network systems may communicate using wireless and/or wired connection, and be utilized to receive inputs, store and process data, and provide outputs for various applications. Network systems may comprise, for example, personal computers (PCs), laptops, servers, workstations, smart phones or other similar handheld mobile devices. A network device may comprise a network interface controller (NIC), which may be coupled internally (i.e. integrated into) or externally to the computer system. The NIC may be utilized in network access operations, to enable sending and/or receiving data, in the form of network packets, via wired and/or wireless connections.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for network interface controller (NIC) address resolution protocol (ARP) batching, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary local network comprising network systems and data forwarding devices, which may be utilized in accordance with an embodiment of the invention.

FIG. 2 is a block diagram illustrating an exemplary network device that may support network interface controller (NIC) address resolution protocol (ARP) batching, in accordance with an embodiment of the invention.

FIG. 3 is a block diagram illustrating an exemplary multiprocessor network device that supports network interface controller (NIC) address resolution protocol (ARP) batching, in accordance with an embodiment of the invention.

FIG. 4A is a flow chart that illustrates exemplary steps for buffering messages during network interface controller (NIC) address resolution protocol (ARP) batching, in accordance with an embodiment of the invention.

FIG. 4B is a flow chart that illustrates exemplary steps for buffering messages in a multiprocessor network device during network interface controller (NIC) address resolution protocol (ARP) batching, in accordance with an embodiment of the invention.

FIG. 5 is a flow chart that illustrates exemplary steps for flushing buffered messages during network interface controller (NIC) address resolution protocol (ARP) batching, in accordance with an embodiment of the invention.

### DETAILED DESCRIPTION OF THE INVENTION

Certain embodiments of the invention may be found in a method and system for network interface controller (NIC) address resolution protocol (ARP) batching. In various embodiments of the invention, a network interface controller (NIC) may provide batching services to a host system associated with the NIC. Batching servicing may comprise delaying forwarding of network packets received via the NIC to the host system by buffering the received network packets within the NIC for extended period of time—i.e. longer than buffering time associated with normal handling of received packets for example. Delay forwarding of the received network packets to the host system may enable delaying handling of the received network packet by the host system. In this regard, the extended buffering of the received network packet may be performed based on a determination that delayed handling of the received network packet by the host system may be permitted. Delaying forwarding of the received packets to the host system, and thus handling of received network packet by the host system, may enable at least one particular component of the host system that is utilized during the handling of the received network packet to remain in power saving states. The particular component may comprise a processor, such as central processing unit (CPU) for example. Accordingly, the batching service may enable reducing and/or optimizing overall system power consumption, by preventing repetitive and/or unnecessary transitions from low power states in instances where the host system, or components thereof are in such states. Furthermore, the NIC may provide such batching servicing without requiring direct knowledge of the power state of the host system, or any component thereof.

Exemplary received network packets that may be batched within the NIC—i.e. buffered within the NIC for extended time, such as until all buffered packets are flushed to the host system—may comprise broadcast Address Resolution Protocol (ARP) packets that do not require response from the host system. At least some of the network packets buffered in the NIC may be forwarded to the host system when one or more flushing conditions occur. Exemplary flushing criteria may comprise receiving a network packet that requires immediate handling by the host system. Exemplary received network packets requiring immediate handling may comprise unicast packets destined for the host system and/or broadcast packets that require response from and/or reply by the host system. Additional flushing conditions may comprise an expiry of buffering timer; reaching and/or exceeding a buffering threshold, which may correspond to, for example, a maximum number of buffered network packets and/or storage space in the NIC; and/or receiving request for network packet transmission from the host system, which may be interpreted as indication that the host system, or particular components thereof, are not in a power saving state.

The NIC may presume that the host system, and/or particular components thereof, may be in power saving state. In this regard, the presumption that a transition to power saving state may have occurred may be based on expiry of a transmission inactivity timer that is run within the NIC. In this regard, the NIC may start the transmission inactivity timer after completion of any network packet transmission performed via the NIC that is associated with the host system. The NIC may also restart the inactivity timer after transaction layer packet (TLP) activity on the NIC Peripheral Component Interconnect Express (PCI-E) interface that may be utilized during interactions between the NIC and the host system. The low power state transition presumption may also be based on observation via the network interface controller that the PCI-E interface has transitioned to certain power state, such as lower power Active State Power Management (ASPM) states (e.g. ASPM L1 state). The presumption of transition to power saving states may also be based on information communicated to the NIC, such as when the NIC receives an Optimized Buffer Flush/Fill (OBFF) message over the PCI-E interface from the host system indicating that the host system may be in lower power state. The NIC may also be configured to always operate with the presumption that the host system, and/or particular components thereof, are in low power state, at least until the NIC receive information, directly or indirectly, indicating that the host system, or particular components thereof, may have transitions from such lower power state, such as when the NIC receive packets for transmittal from the host system.

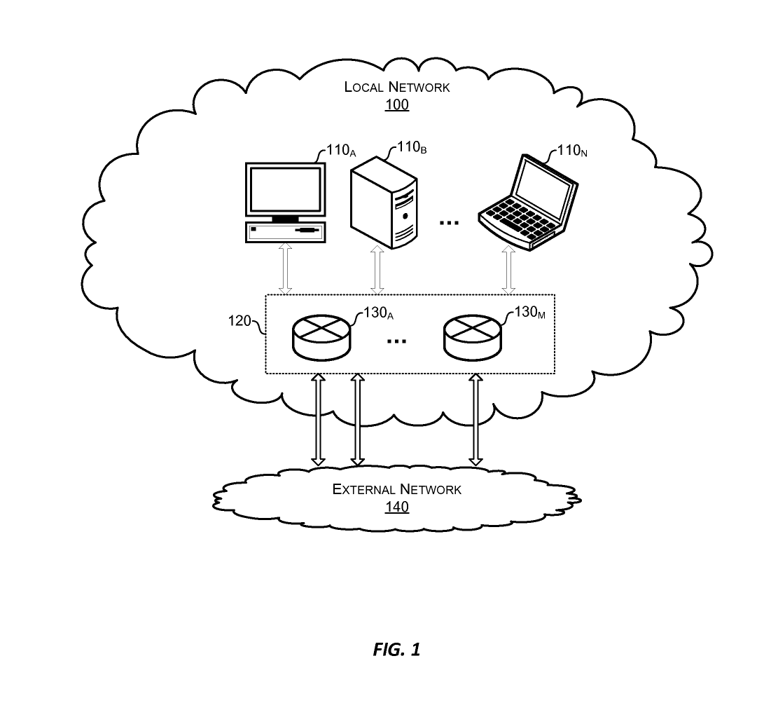

FIG. 1 is a block diagram illustrating an exemplary local network comprising network systems and data forwarding devices, which may be utilized in accordance with an embodiment of the invention. Referring to FIG. 1, there is shown a local network 100, a plurality of network systems 110_{A}-110_{N}, a data forwarding system 120, and a plurality of data forwarding devices 130_{A}-130_{M}. Also shown in FIG. 1 is an external network 140.

The local network 100 may comprise a plurality of systems devices, and/or entities, which may be co-located within a small geographical area, and may be inter-connected directly and/or via one or more intermediate devices within the local network 100. In this regard, connectivity within the local network 100 may be provided using wired connections, such as Ethernet connections, over twisted pair cabling for example, and/or using wireless connections, such as Wi-Fi based connections for example. The local network 100 may comprise, for example, the plurality of network systems 110_{A}-110_{N}, and the data forwarding system 120. The data forwarding system 120 may comprise the plurality of data forwarding devices 130_{A}-130_{M}. In this regard, the network systems 110_{A}-110_{N} may be operable to transmit and/or receive data via network packets, internally within the local network 100, to and/or from other systems within the local network 100, and/or external to the local network 100, to and/or from other systems or devices that may be located outside the local network 100, which may be accessed via the external network 140 for example. Some of the communication from and/or to network systems 110_{A}-110_{N} may be forwarded via the data forwarding system 120.

Each of the network systems 110_{A}-110_{N} may comprise suitable logic, circuitry, interfaces, and/or code that may be operable to perform various tasks and/or execute applications based on, for example, preloaded instructions and/or user input. Exemplary network systems may comprise personal computers (PCs), laptops, servers, mainframes, set-top-boxes (STBs), printers, smart phones or other similar handheld mobile devices. Each of the network systems 110_{A}-110_{N} may communicate data, during performance of tasks and/or execution of applications for example. In this regard, each of the network systems 110_{A}-110_{N} may transmit and/or receive network packets carrying that data to and/or from other network systems, directly, via inter-device connections, and/or indirectly, via intermediaries such as the data forwarding system 120 and/or the external network 140 for example. The network systems 110_{A}-110_{N} may utilize network links for data communication, which may comprise, for example, wired based Ethernet links, such as 10 Gigabit Ethernet (10 GbE) based links, and/or wireless links, such as WiFi (802.11) based links.

The data forwarding system 120 may comprise suitable logic, circuitry, interfaces, and/or code for performing data forwarding services in the local network 100. In this regard, data forwarding services may comprise, for example, switching, routing, and/or bridging. The data forwarding system 120 may comprise the plurality of data forwarding devices 130_{A}-130_{M}. The data forwarding devices 130_{A}-130_{M} may comprise, for example, routers, bridges, gateways, firewalls, switches, and/or any combinations thereof. The data forwarding system 120 may provide internal and/or external forwarding of data communicated to and/or from the network systems 110_{A}-110_{N}, within the local network 100, and/or to and/or from the external network 140 for example. Data forwarding operations performed by the data forwarding system 120 may be implemented via one or more networking layers based on, for example, the Open Systems Interconnection (OSI) Model. For example, the data forwarding system 120 may be operable to perform L2, L3, L4, VLAN, and/or any other higher and/or additional protocol layer based data forwarding, for example, switching and/or routing. In an exemplary aspect of the invention, the data forwarding system 120 may also provide internal data forwarding within the local network 100, to enable and/or support data communication internally within the local network 100, among the network systems 110_{A}-110_{N} for example.

The network 140 may comprise a system of interconnected networks and/or devices which may enable exchange of data among a plurality of nodes, based on one or more networking standards, including, for example, Internet Protocols (IP). The network 140 may comprise a plurality of broadband capable subnetworks, which may comprise, for example, satellite networks, cellular network, cable networks, DVB networks, the Internet, and/or other local area networks (LANs) or wide area networks (WANs). These subnetworks may collectively enable conveying data, via Ethernet packets for example, to a plurality of end users. In this regard, physical connectivity within, and/or to or from the network 140, may be provided via copper wires, fiber-optic cables, wireless interfaces, and/or other standards-based interfaces. The network systems 110_{A}-110_{N} may obtain external networking connectivity by accessing the network 140, via the data forwarding system 120, for example.

In operation, the local network 100 may provide network accessibility to the network systems 110_{A}-110_{N}, to support applications and/or processes running and/or executing in the network systems 110_{A}-110_{N}. In this regard, the network systems 110_{A}-110_{N} may be operable to transmit and/or receive network packets. The network packets may be exchanged among the network systems 110_{A}-110_{N}, internally within the local network 100, using direct inter-device connections and/or indirectly through the data forwarding subsystem 120. Furthermore, at least some of the network systems 110_{A}-110_{N} may be operable to transit and/or receive network packets to and/or from devices or entities located external to the local network 100, which may be reached via the network 140 for example.

In an exemplary aspect of the invention, at least some of the network systems 110_{A}-110_{N} may be operable to implement and/or utilize various power management techniques, to optimize power consumption during operations of these devices. In this regard, power management techniques may comprise utilizing various power modes or states, which may comprise power saving modes or states, associated with operations of the network systems 110_{A}-110_{N}, and/or particular components thereof. In this regard, transitions between these power modes or states may be performed under certain conditions and/or criteria, to enable reducing power consumption where the modes or states transitioned to may comprise power saving modes or states. In the power saving modes or states, the power saving may be achieved by turning off, slowing, and/or disabling certain functions and/or operations compared to, for example, active modes or states.

The network systems 110A-110N may comprise, for example, processors, such as central processing units (CPUs), which may support various processor states, with varying associated power consumption criteria based on operations and/or functions that may remain available in these processor states. For example, processor states may comprise processor power management states Cx, with x being a positive integer starting with ‘0’ with power saving associated with these states increasing with increasing values of x, as defined by the Advanced Configuration and Power Interface (ACPI) specification. The processor power management states Cx may also comprise additional states beyond those defined by the ACPI specification, such as states that may be defined by particular manufactures. In this regard, an exemplary list of processor power management states defined by the ACPI specification may comprise C0, C1, C2, and C3, with C0 corresponding to fully active state. Additionally defined states, which may correspond to particular manufactures such as Intel or AMD, may comprise C1E, C4, C5, and C6.

The C0 processor power management state may correspond to fully active state, wherein every function and/or component of a processor is enabled and/or running. Accordingly, transitions from the C0 processor state to other states, such as C1, C1E, C2, or C3, may entail shutting off and/or disabling certain functions and/or components of the processor to reduce power consumption. The processor may transition between the processor states based on certain conditions, wherein transitions from power saving processor states to fully active state (C0) or less power saving state may require reactivating the processor and/or certain components or functions thereof. The processor power management states Cx may also be utilized in conjunction with use of power saving modes for other associated components, such as use of the Active State Power Management (ASPM) power management protocol which may enable utilizing power saving modes in conjunction with operations of PCI Express (PCI-E) based interconnects within the network systems 110A-110N.

In various embodiments of the invention, network access functions and/or operations in the network systems 110_{A}-110_{N} may be configured and/or managed to support and/or supplement other power management techniques used in the network systems 110_{A}-110_{N}. This may comprise buffering and delaying handling of received network packets, within the network systems 110_{A}-110_{N}, under certain conditions to enhance and/or optimize power consumption in these devices. In this regard, handling of network packets may require that the network systems 110_{A}-110_{N} and/or certain components thereof (e.g. processors) be in active states. Network systems, such network systems 110_{A}-110_{N}, may not be able to take advantage of various existing power management functions, such as lowest power processor states, due to, for example, exposure to activities in networks to which these systems may be coupled even though these activities may not pertain to the particular systems. For example, systems may not be able to remain idle, and are not running active user applications and/or tasks, when these systems are coupled to a network with substantial background broadcast activity requiring consistent handling of broadcast packets, even those that may not be directed to these systems. Reception of such “background” packets from the network may require various components of the systems, such as a CPU, to be active and thus may require transition from lowest power states in order to “process” the incoming packets. For example, the background broadcast packets may comprise broadcast Address Resolution Protocol (ARP) packets utilized for soliciting a Mac address associated with certain IP address that may not match the IP address of the receiving system, or gratuitous broadcast ARP packets advertising the IP/Mac address of another system. Since these types of ARP packets are Broadcast packets, they are received by all systems connected to the network (subnet) that the packet originated from even though at most only one system should need to respond to that packet.

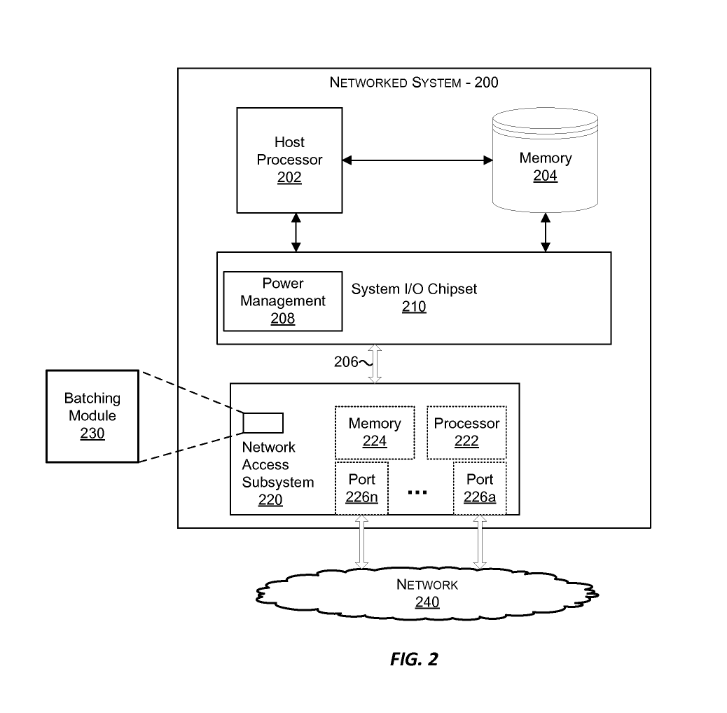

The number and/or frequency of such “background” broadcast ARP packets may be significant in some networks. Accordingly, immediate handling of all received broadcast packets may not be desirable because the number and frequency of these packets may be such that the receiving system, or particular components thereof (e.g. CPU) may ultimately be prevented from ever transitioning to or remaining in lower power states or modes. While some of these issues may be addressed by, for example, configuring the NIC to drop and/or discard such broadcast packets that are not directed to the receiving system, such approach may not be desirable. For example, in some instances all systems receiving certain broadcast packets must handle such packets even when these packets are not directed to them. This may be mandated by, for example, TCP/IP implementations and/or ARP protocol specifications, which may require that all systems receiving such broadcast packets process these packets, to update, for example, local tables based on the contents of the packets even if no response to the received packets is needed. Accordingly, when a network packet is received, a determination may be performed as to whether the received network packet requires immediate handling, and if not, the received network packet may be buffered, within the NIC that receives the packets, to delay handling of such packets. This may enable reducing power consumption in instances where the network systems 110_{A}-110_{N} as whole, or particular components thereof which may be utilized in handling the received network packet, may be in low power states or modes. This may reduce power consumption in the network systems 110_{A}-110_{N} by preventing unnecessary and/or frequent transitions from low power states to active states. Determining when delaying handling of particular network packets may be allowed may be performed based on, for example, conditions or criteria, which may be predetermined and/or preconfigured, and/or may be continually updated and/or modified thereafter, based on user preferences for example. Determining whether a received network packet requires immediate handling, or that handling of the received network packet may be delayed, may be based on, for example, the type of the network packet. For example, received network packets may comprise broadcast network packets, which may be broadcasted by one of the network systems 110_{A}-110_{N} to all of remaining systems in the local network 100 even though these packets are only intended for, and require immediate response by only one of the systems. One example of such broadcast packets is broadcast address resolution protocol (ARP) packets. Handling of such broadcast ARP packets, in accordance with an embodiment of the invention, is described in more detail below with respect to FIG. 2.

FIG. 2 is a block diagram illustrating an exemplary networked system that may support network interface controller (NIC) address resolution protocol (ARP) batching, in accordance with an embodiment of the invention. Referring to FIG. 2, there is shown a networked system 200, a host processor 202, a system memory 204, a system I/O bus 206, a power management unit 208, a system input/output (I/O) chipset 210, a network access subsystem 220, and a network 240.

The networked system 200 may correspond to one or more of the network systems 110_{A}-110_{N}, substantially as described with regard to FIG. 1. Accordingly, the networked system 200 may be a personal computer (PC), a laptop, a server, a mainframe, a set-top-box, a printer, a smart phones or a similar handheld mobile device. The networked system 200 may comprise, for example, the host processor 202, the system memory 204, the system I/O bus 206, the I/O chipset 210, and/or the network access subsystem 220. In this regard, the host processor 202 may enable executing various tasks and/or applications in the networked system 200, and/or may also provide control and/or management of operations of the networked system 200. The I/O chipset 210 may enable user interactions with the networked system 200. The network access subsystem 220 may enable communication of data from and/or to the networked system 200, during execution of tasks and/or applications in the networked system 200 for example. The networked system 200 may also comprise other hardware resources (not shown) such as a graphics card and/or a peripheral sound card, for example.

The host processor 202 may comprise suitable logic, circuitry, interfaces and/or code that may be operable to process data, and/or control and/or manage operations of the networked system 200, and/or tasks and/or applications performed therein. In this regard, the host processor 202 may be operable to configure and/or control operations of various components and/or subsystems of the networked system 200, by utilizing, for example, one or more control signals. The host processor 202 may also control data transfers within the networked system 200. The host processor 202 may enable execution of applications, programs and/or code, which may be stored in the system memory 204 for example. The host processor 202 may be comprised of a single processor core, or multiple processor cores, and/or multiple physical processors.

The system memory 204 may comprise suitable logic, circuitry, interfaces and/or code that enable permanent and/or non-permanent storage and/or fetching of data, code and/or other information used in the networked system 200. In this regard, the system memory 204 may comprise different memory technologies, including, for example, read-only memory (ROM), random access memory (RAM), and/or Flash memory. The system memory 204 may store, for example, configuration data, which may comprise parameters and/or code, comprising software and/or firmware, but the configuration data need not be limited in this regard.

The system I/O bus 206 may comprise suitable logic, circuitry, interfaces, and/or code that may enable exchange of data and/or messages between various components and/or systems in the networked system 200. In this regard, the system bus may comprise parallel or serial, and/or internal or external based bus technologies, and/or any combinations thereof. Exemplary system bus interfaces may comprise Peripheral Component Interconnect (PCI), Peripheral Component Interconnect Express (PCI-E), Inter-Integrated Circuit (I²C), or Universal Serial Bus (USB).

The power management unit 208 may comprise suitable logic, circuitry, interfaces, and/or code that may be operable to control power management in the networked system 200. In this regard, power management may comprise use of power states associated with the networked system 200 as a whole and/or power states associated with particular components of the networked system 200, such as the host processor 202. The power management unit 208 may be implemented as a dedicated physical component, or as part of the system I/O chipset. Alternatively, at least a portion of the power management unit 208 may be implemented as software (or firmware) module, and at least some of the operations and/or functions described with respect to the power management unit 208 may be performed by another component of the networked system 200, such as the host processor 202 for example. In this regard, power management operations and/or functions described with respect with the power management unit 208 may be programmed into the host processor 202, and/or may be updated and/or modified thereafter, via direct interactions with the I/O chipset 210 and/or download from remote location, using network access of the networked system 200 for example.

The I/O chipset 210 may comprise suitable logic, circuitry, interfaces, and/or code that may enable inputting and/or outputting of data and/or messages, to support user interactions with the networked system 200, to receive user input and/or provide user output. For example, the I/O chipset 210 may facilitate interactions with the networked system 200 via one or more I/O devices, such as a monitor, a mouse, and/or keyboard.

The network access subsystem 220 may comprise suitable logic, circuitry, interfaces, and/or code that may be operable to communicate data and/or messages from and/or to the computer system 200. The network access subsystem 220 may comprise, for example, a network interface controller (NIC). The network access subsystem 220 may comprise, for example, a networking processor 222, a networking memory 224, and/or a plurality of ports 226_{A}-226_{N}. The networking processor 222 may comprise suitable logic, circuitry, interfaces, and/or code for controlling and/or managing operations of the network access subsystem 220. The networking memory 224 may comprise suitable logic, circuitry, interfaces and/or code for dedicated local storage and/or buffering of data within the network access subsystem 220. In this regard, the networking memory 224 may comprise one or more ROM, RAM, Flash, SSD, and/or FPGA devices. Each of the plurality of ports 226_{A}-226_{N} may comprise suitable logic, circuitry, interfaces, and/or code for providing network interfacing functionality, in the network access subsystem 220, based on one or more networking standards and/or protocols. The plurality of ports 226_{A}-226_{N} may comprise, for example, 10 GbE ports. The network access subsystem 220 may support and/or perform, for example, physical (PHY) layer related access, via the plurality of ports 226_{A}-226_{N}, and/or processing therefor. The network access subsystem 220 may also support and/or perform Media Access Control (MAC) layer related processing (e.g. addressing and/or channel access) corresponding to one or more supported networking standards. In this regard, exemplary network standards may comprise wired based standards, such as Ethernet, Digital Subscriber Line (DSL), Integrated Services Digital Network (ISDN), and/or Fiber Distributed Data Interface (FDDI); or wireless standards, such as WLAN (IEEE 802.11).

In an exemplary embodiment of the invention, the network access subsystem 220 may provide a batching service in the networked system 200. In this regard, batching services may comprise buffering network packets within the network access subsystem 220 in instances where handling of these network packets may be delayed, and keeping those packets buffered within the network access subsystem 220 until at least one flushing criterion is met. Flushing criteria used to trigger flushing of buffered packets may be predetermined and/or configurable. The batching services may support power management operations in the networked system 200, by preventing unnecessary transitions from power saving states for example. The network access subsystem 220 may comprise a batching module component 230, which may comprise suitable logic, circuitry, interfaces, and/or code that may be operable to provide batching services by the network access subsystem 220. The batching module component 230 may be implemented as a dedicated physical component. The batching module component 230 may also be implemented as software (or firmware) component, and operations and/or functions described with respect to the batching module component 230 may be performed by existing physical components of the network access subsystem 220, such as the network processor 222 for example. In this regard, batching services described with respect with the batching module component 230 may be programmed into the network access subsystem 220, and/or may be updated and/or modified thereafter, based on direct interactions with the networked system 200, using the I/O chipset 210 for example, and/or based downloaded updates from remote location, using network access of the networked system 200 for example.

The network 240 may comprise a system of interconnected networks and/or devices for exchanging data among a plurality of nodes, based on one or more networking standards, which may enable communication of data, via Ethernet packets for example, between the networked system 200 and one or more other devices. Physical connectivity within, and/or to or from the network 240, may be provided via copper wires, fiber-optic cables, wireless links, and/or other standards-based interfaces. The network 240 may correspond to, for example, the external network 140 and/or at least a portion of the switching subsystem 120 of the local network 100, substantially as described with respect to FIG. 1.

In operation, the networked system 200 may perform various tasks and/or execute applications based on, for example, preloaded instructions and/or user input, which may be provided via the I/O chipset 210 for example. The networked system 200 may transmit and/or receive data and/or messages, such as during performance of tasks and/or execution of applications in the networked system 200, for example. In this regard, the networked system 200 may communicate network packets, which may carry data and/or messages, to and/or from the network 240, via one or more of the ports 226_{A}-226_{N} for example. The networked system 200 may also be also operable to implement and/or utilize various power management techniques, via the power management unit 208 for example, to enable optimizing power consumption during operations of networked system 200. These power management operations may comprise utilizing power states associated with operations of the networked system 200, and/or particular components thereof. In this regard, at least some of the power states may comprise power saving states, wherein power savings may be achieved in power saving states by turning off, slowing, and/or disabling certain functions and/or operations compared to, for example, active states.

The power management unit 208 may be operable to force, using control signals for example, transitions between various power states based on preconfigured and/or predetermined criteria or parameters. For example, the power management unit 208 may be operable to implement and/or utilize ACPI based processor power management states Cx in conjunction with the host processor 202. In this regard, the power management unit 208 may force the host processor 202, via use of control signals for example, to transition between various processor states Cx based on preconfigured and/or predetermined criteria, such as when the networked system 200 does not receive network packets or user input for some given duration, which may be configured and/or modified, by use of internal activity timers. In addition to use of ACPI processor power management states Cx, the power management unit 208 may also be operable to utilize power saving modes associated with other components. For example, the power management unit 208 may utilize ASPM based power saving modes in conjunction with operations of system I/O bus 206 in instances where the system I/O bus 206 may comprise PCI Express (PCI-E) based interconnects within the networked system 200.

In various exemplary embodiments of the invention, the batching module component 230 may provide batching services in the networked system 200, to support power management operations and/or functions provided therein. In this regard, batching services may comprise determining whether incoming network packets received via the network access subsystem 220 require immediate handling by the networked system 200 or if that handling may be delayed. The received network packets may then be buffered for a longer duration within the network access subsystem 220, such as within the networking memory 224 for example, in instances where handling of these network packets may be delayed. Buffering the received network packets for a longer duration within the network access subsystem 220 may enable optimizing power consumption in the networked system 200 by maintaining power saving states of the networked system 200 and/or particular components of the networked system 200 which may be utilized in handling the received network packets. In this regard, delaying handling of the received network packets, may enable preventing frequent and/or unnecessary transitions from the power saving states.

In this regard, because processors such as the host processor 202 typically consume substantial power in a platform such as the networked system 200, power consumption may be enhanced and/or optimized by ensuring that when the host processor 202 transitions to processor power state Cx that may be a low power state (e.g. C1, C2, or C3), the host processor 202 may remain in such low power state as long as possible. Transitions to such low power states and/or remaining in such states usually require that the processor be idle for significant periods of time. Accordingly, delaying handling of network packets may enable enhancing power consumption optimization by ensuring that the host processor 202, which is utilized in handling such network packets, may remain idle to trigger transitions to such low power state(s) and/or remaining in such low power states for a longer duration. Without use of such mechanisms as the batching services provided by the network access subsystem 220, the host processor 202 may have to continually remain in active power state, C0, due to particular network traffic and/or operations which may not directly involve and/or be intended for the networked system 200.

For example, even in instances where the networked system 200 is not running any active applications, performing any task, or initiating any networking activity, the networked system 200 may still receive “background” network packets from the network 240. In this regard, while such “background” network packets may not directed to the networked system 200, the networked system 200 may still be required to handle these packets, thus requiring the host processor 204, for example, to transition from a low power Cx state if the host processor 204 was in such state, to process the incoming packets. The “background” packets may comprise broadcast packets which may be communicated to a plurality of network device and/or systems, at least some of which may not really be the intended target of such communications. In one embodiment of the invention, the “background” packets may comprise Address Resolution Protocol (ARP) packets. In this regard, exemplary ARP packets that be communicated to a plurality of network systems in a network, such as in a local network like the local network 100 of FIG. 1, may comprise ARP packets transmitted to multiple devices soliciting the Media Access Control (MAC) address associated with a particular IP address, which may not necessarily match the IP address of the networked system 200. The broadcast ARP packets may also comprise gratuitous ARP packets which may advertise the IP/Mac address of another system or device.

Since these types of ARP packets are broadcast packets, they are received by all devices and/or systems connected to a particular network, such as the local network 100, even though only one device may need to generate a response on the network 100 to that packet. Some of these packets, however, may require all recipient devices, including those that are not the intended recipient device, to take some action (e.g. updating its ARP table) based on information included in the received ARP packets. Consequently, while some of the incoming ARP packets received by the network access subsystem 220 of the networked system 200 may not actually necessitate a response to these packets, or an immediate response, such as when they are targeted for a different device, handling these packets may require the networked system 200 to exit low power processor Cx state if the system is in such state, and transition to the active state C0 to handle these packets. In some instances, the number of such “background” packets may be large enough that the networked system 200 may not be able to transition to any of the low power states Cx, and may have to remain in the active state C0.

In some instances, the host processor 202 may be protected from unnecessary transitions to active state C0, by simply dropping some of the received packets by the network access subsystem 220 rather than forwarding and thus necessitating that the host processor 202 transition from low power state. Some of the received broadcast packets, however, may not be dropped even when they are not intended for the networked system 200. For example, the ARP protocol mandates that at least certain received broadcast ARP packets be handled even in instances where they receiving network device is not the intended device. The receiving (non-intended) device may be required to process such ARP packets to update its own ARP related tables and/or information for example. Such processing, however, need not be performed immediately, and may be delayed in such instances as when the host processor 202 may be in a power saving processor state Cx.

The batching module component 230 may determine, for example, whether an incoming network packet received via the network access subsystem 220 may (not) require immediate handling by the host processor 202. This determination may be performed based on the packet type. For example, the batching module component 230 may determine whether the received network packet comprises a broadcast ARP packet, and if so, whether it is intended for the network device or not. In this regard, the batching module component 230 may determine if the received broadcast ARP packet is intended for the networked system 200 by comparing the IP address of the networked system 200 with the target IP address included in the received ARP packet. In instances where the received network packet may not require immediate handling by the networked system 200, the batching module component 230 may determine whether the networked system 200, or a particular component thereof such as the host processor 202, may be in a power saving state. The batching module component 230 may then buffer the received network packet for a longer duration within the network access subsystem 220, such as within the networking memory 224 for example, when handling the received network packet requires transitioning from such power saving state. In this regard, batching module component 230 may be operable to allocate a portion of the networking memory 224 for use in buffering network packets in accordance with batching operations.

Determining whether the networked system 200, or a particular component thereof is in a power saving state may be performed based on information communicated to the batching module component 230. For example, the power management unit 208 may notify the batching module component 230 when the host processor 202 transitions to a low power processor state Cx. This could be done via PCIE Optimized Buffer Flush/Fill (OBFF) messages. The batching module component 230 may also autonomously determine whether the networked system 200, or a particular component thereof, is in a power saving state. For example, the batching module component 230 may presume that the host processor 202 had transitioned to a low power processor state Cx if the network access subsystem 220 does not receive any network packets, data, or requests for transmission by the networked system 200 for certain duration. In this regard, the batching module component 230 may run a timer to keep track of such networking inactivity by the networked system 200, which may be restarted after a last transmission by the networked system 200. Upon expiry of such inactivity timer, the batching module component 230 may operate on the presumption that a transition to power saving state had occurred. In this regard, the duration of the inactivity timer may be initialized, and/or maybe configurable and/or modifiable thereafter. The batching module component 230 may also optionally presume that the host processor 202 is always in a low power state.

The batching module component 230 may also drop a received network packet, whose handling may be delayed, if it is determined that the received network packet is a duplicate of a previously received and buffered packet. This may further enhance power consumption by reducing the processing load that may be incurred by the host processor 202 when buffered packets are eventually forwarded by reducing the number of packets that may need to be handled by the host processor 202 for example.

The batching module component 230 may be operable to flush (or forward) buffered network packets, wherein the buffered network packets may be forwarded to other components in the networked system 200 for handling. Forwarding of buffered network packets may be performed using direct memory access (DMA) functions for example, to enable copying the buffered network packets from the networking memory 224 to the system memory 204 for example. Furthermore, buffering and/or flushing of network packets may be configured to ensure maintaining reception order of the network packets. In this regard, the buffered network packets may be stored into the networking memory 224 based on a particular order, which may be maintained using queues, pointers, and/or link lists for example, and flushing of the buffered network packets may subsequently performed in accordance with the same order as the buffering operations, to ensure first-in-first-out (FIFO) based forwarding operations.

The buffered network packets may be forwarded when one or more flush conditions or criteria may be met. The flush conditions and/or criteria may be predetermined and/or preconfigured, and/or may be continually updated and/or modified thereafter, based on user preferences for example. Exemplary flush conditions or criteria may comprise reception of an incoming non-broadcast network packet that may be destined for the network device; reception of an incoming broadcast network packet that is determined to require an immediate handling by the network device, such as an ARP packet that this is targeted for the networked system 200; and/or receiving a request for transmission by the network device, which may implicitly indicate that the networked system (or a particular component thereof such as the host processor 202) is active and therefore is not in a power saving state. Another flush condition may be expiry of a flushing timer which may be run by the batching module component 230. In this regard, upon expiry of the flushing timer, the batching module component 230 may forward at least some of the buffered network packets. The duration of the flushing timer may be initialized, and/or may be configurable and/or modifiable thereafter. Another flush condition or criterion may number of buffered network packets, which be based on predetermined storage threshold for the network access subsystem 220. In this regard, the storage threshold may be determined based on available storage space in the network access subsystem 220, such as based on size of free space in the networking memory 224 for example.

In an embodiment of the inventions, operations of the batching module component 230 may correlated to and/or combined with support of power management and/or optimization functions in the network access subsystem 220. For example, buffering and/or flushing related operations of the batching module component 230 may be tied to support of PCI-E related power management modes and/or functions in the network access subsystem 220, in instances where interactions via the system I/O bus 206 may utilize PCI-E based interconnects. For example, operations of the batching module component 230 related to delaying the forwarding of packet to the host processor 202 may be disabled unless the PCI-E interface of the network access subsystem 220 transition to ASPM L1 state. In addition, transitions of ASPM state of the PCI-E interface of the network access subsystem 220 from L1 to L0 may be used as one of the flush criteria for buffered network packets. Operations of the batching module component 230 may also optionally be tied to support for the PCI-E “Optimized Buffer Flush/Fill” Engineering Change Notice (ECN).

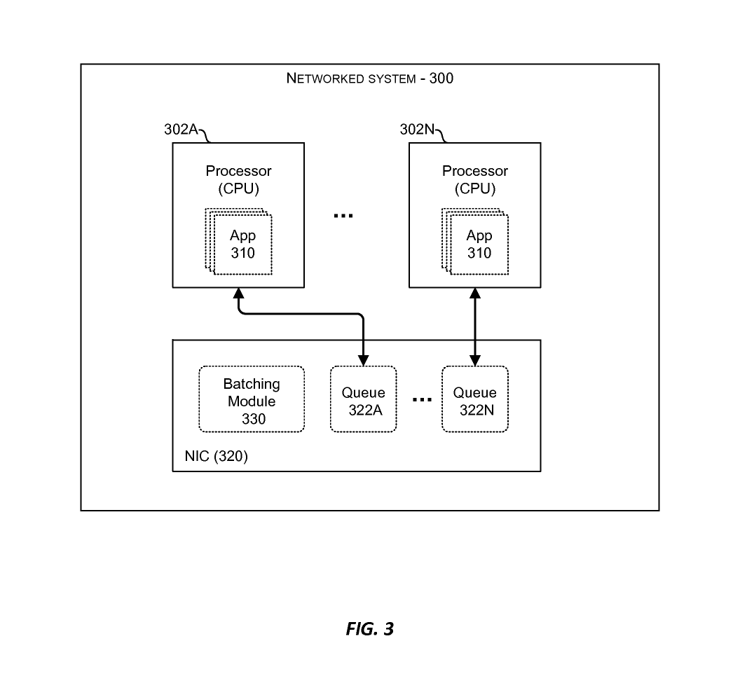

FIG. 3 is a block diagram illustrating an exemplary multiprocessor network device that supports network interface controller (NIC) address resolution protocol (ARP) batching, in accordance with an embodiment of the invention. Referring to FIG. 3, there is shown a multiprocessor networked system 300, a plurality of processors 302_{A}-302_{N}, and network interface controller (NIC) 320.

The networked system 300 may be similar to the networked system 200, substantially as described with regard to FIG. 2. The networked system 300, however, may be implemented as a multiprocessor platform. In this regard, the networked system 300 may comprise the plurality of processors 302_{A}-302_{N}. Each of the processors 302_{A}-302_{N} may be similar to the host processor 202, substantially as described with regard to FIG. 2. In an exemplary aspect of the invention, each of the processors 302_{A}-302_{N}, however, may operate independent of the remaining processors. Accordingly, each of the processors 302_{A}-302_{N} may be operable to transition to different power state independent of the remaining of the remaining processors in the networked system 300.

The networked system 300 may also comprise the NIC 320, which may be similar to the network access subsystem 220, substantially as described with regard to FIG. 2. Furthermore, the NIC 320 may be operable to support a multiprocessor environment in the networked system 300. In this regard, the NIC 320 may comprise a plurality of queues 322_{A}-322_{N}, each of which may be tied and/or infinitized to corresponding one of the processors 302_{A}-302_{N}, to support communication of data to and/or from corresponding one of the processors 302_{A}-302_{N}. In an exemplary aspect of the invention, the NIC 320 may comprise a batching module component 330, which may be similar to the batching module component 230, substantially as described with regard to FIG. 2.

In operation, the NIC 320 may provide batching operations, utilizing the batching module component 330, substantially as described with regard to FIG. 2 for example. The batching module component 330 may also be configured to specifically support the multiprocessor environment in the networked system 300. In this regard, network packet buffering and/or flushing policies and/or parameters may be specifically configured and/or adjusted to accommodate presence of the multiple processors 302_{A}-302_{N}, and/or independent operations thereof. The packet buffering and/or flushing functions performed by the batching module component 330 may be configured and/or adjusted to provide, for example, per-processor servicing, to account for the fact that each of the processors 302_{A}-302_{N} may have different processor power states. For example, while the processor 302_{A} may be in active processor state C0, the processor 302_{N} may be in a power saving processor state Cx, such as C1, C2, or C3 for example. Accordingly, the batching module component 330 may be configured to forward incoming network packets destined for processor 302_{A}, while batching, if such batching is permitted, when delayed handling is allowed, incoming network packets destined for processor 302_{N}.

The batching module component 330 may determine the destination of received network packets—e.g. one of the processors 302_{A}-302_{N}—based on receive which queue is utilized in receiving the incoming network packet. For example, incoming network packets received via queue 322_{A} may be presumed to be destined for processor 302_{A}, while incoming network packets received via queue 322_{N} may be presumed to be destined for processor 302_{N}. Accordingly, network packet buffering and/or flushing may be performed on per-processor basis, based on the queue tied and/or infinitized to particular processor. In this regard, buffering and/or flushing criteria and/or operations may be performed separately on each of the receive queues 322_{A}-322_{N}. Similarly, additional related functions, such as allocation of buffering space and/or determination of whether the corresponding components (e.g. processor) is in power saving states may also be performed independently, such as on per-processor basis.

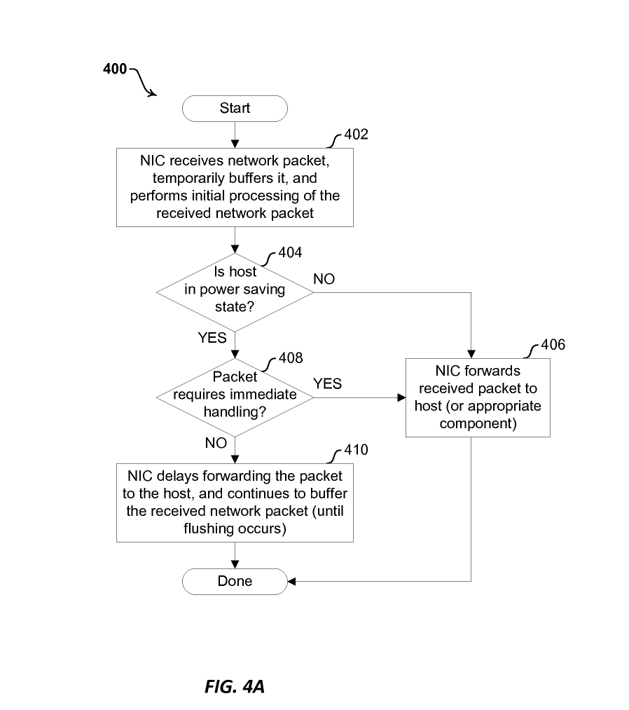

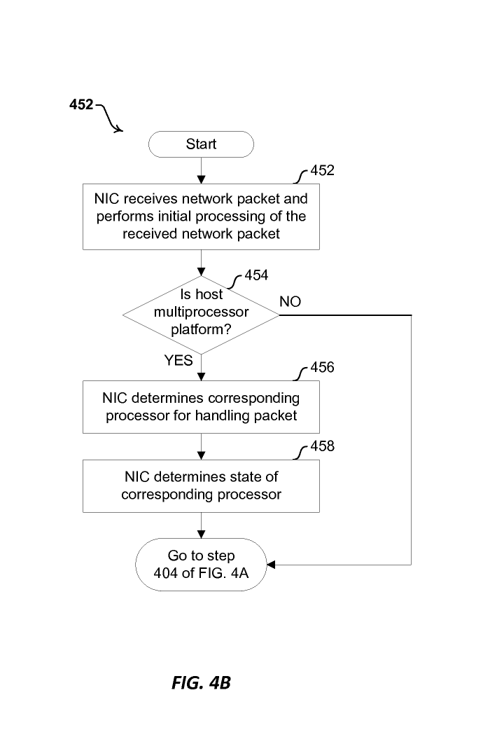

FIG. 4A is a flow chart that illustrates exemplary steps for buffering messages during network interface controller (NIC) address resolution protocol (ARP) batching, in accordance with an embodiment of the invention. Referring to FIG. 4, there is shown a flow chart 400 comprising a plurality of exemplary steps that may be performed in a network interface controller (NIC) to provide message buffering during address resolution protocol (ARP) batching.

In step 402, the NIC, such as the network access subsystem 220 of the networked system 200, may receive a network packet and may perform initial processing of the received network packet. In step 404, the NIC may determine whether the host (or particular component thereof), to which the received network packet is destined, may be in power saving state. In instances where the NIC determines that the host is not in a power saving state, the plurality of exemplary steps proceeds to step 406. In step 406, the NIC may forward the received packet to host, or appropriate component thereof.

Returning to step 404, in instances where the NIC determines that the host is in a power saving state, the plurality of exemplary steps proceeds to step 408. In step 408, the NIC may determine whether the received packet requires immediate handling. In instances where the NIC determines that the received packet requires immediate handling by host, the, the plurality of exemplary steps proceeds to step 406.

Returning to step 408, in instances where the NIC determines that the received packet does not require immediate handling by host, the plurality of exemplary steps proceeds to step 410. In step 410, the NIC delays forwarding the packet to the host, and the packet remains buffered in the NIC until packet flushing is performed by the NIC.

FIG. 4B is a flow chart that illustrates exemplary steps for buffering messages in a multiprocessor network device during network interface controller (NIC) address resolution protocol (ARP) batching, in accordance with an embodiment of the invention. Referring to FIG. 4B, there is shown a flow chart 450 comprising a plurality of exemplary steps that may be performed in a multiprocessor network interface controller (NIC) to provide message buffering during address resolution protocol (ARP) batching.

In step 452, the NIC, such as NIC 320 of the networked system 300, may receive network packet and may perform initial processing of the received network packet. In step 454, the NIC may determine whether the host that comprises the NIC is a multiprocessor platform. In instances where the NIC determines that the host comprises not a multiprocessor platform, the plurality of exemplary steps may jump to step 404 of FIG. 4A, and may continue therefrom in accordance with flow chart 400. Returning to step 454, in instances where the NIC determines that the host is a multiprocessor platform, the plurality of exemplary steps proceeds to step 456. In step 456, the NIC may determine the processor of the host associated with and/or may be utilized to handle the received packet. In this regard, the NIC 320 may determine which of the processors 302_{A}-302_{N} should receive the network packet. The determination may be based on which of the receive queues 322_{A}-322_{N} that was utilized in receiving the network packet, and/or determining the processor tied and/or infinitized thereto. In step 458, the NIC may determine the power state of the corresponding processor determined in step 456. The plurality of exemplary steps may then jump to step 404 of FIG. 4A, and may continue there from in accordance with flow chart 400.

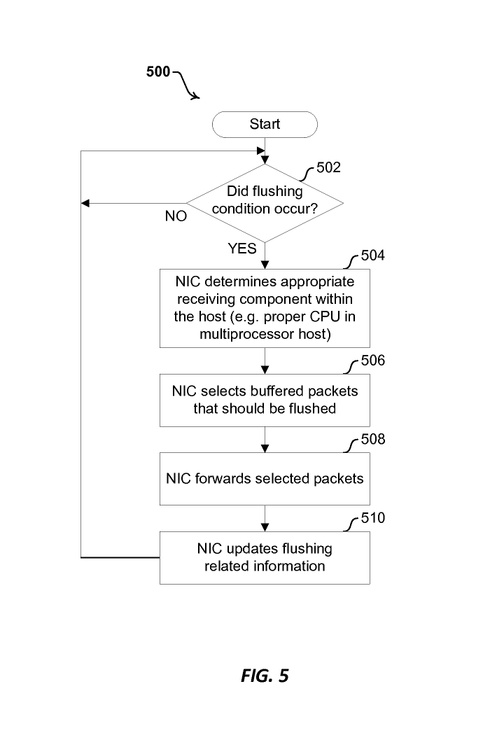

FIG. 5 is a flow chart that illustrates exemplary steps for flushing buffered messages during network interface controller (NIC) address resolution protocol (ARP) batching, in accordance with an embodiment of the invention. Referring to FIG. 5, there is shown a flow chart 500 comprising a plurality of exemplary steps that may be performed in a network interface controller (NIC) to provide message flushing during address resolution protocol (ARP) batching.

In step 502, the NIC, such as the network access subsystem 220 of the networked system 200 or the NIC 320 of the networked system 200, may determine whether a packet flushing condition had occurred. In this regard, flushing conditions may comprise reception of an incoming network packet that may require immediate handling; an expiry of a buffering timer that may be run by the NIC; reaching or exceeding a maximum buffering threshold, which may be based on utilized storage space and/or total number of buffered network packets; and/or receiving a request for transmission by the NIC (i.e. outgoing transmission), which may indicate that the host system, or at least a particular component thereof that is utilized in handling the buffered network packets, may have transitioned out of power saving states. In instances where no packet flushing condition occurs, the plurality of exemplary steps may loop back and recheck for occurrence of packet flushing conditions. Returning to step 502, in instances where the NIC determines that at least one packet flushing condition had occurred, the plurality of exemplary steps proceeds to step 504. In step 504, the NIC may determine the appropriate receiving component within the host, including proper processor in multiprocessor host for example. In step 506, the NIC may select buffered packets that may be flushed. In step 508, the NIC may forward selected packets. In step 510, the NIC may update packet flushing related information and/or parameters, when needed. For example, in instances where the flushing condition that occurred was expiry of flushing timer, the flushing timer may be reset, and/or may be restarted thereafter, such as upon buffering of a network packet.

Various embodiments of the invention may comprise a method and system for network interface controller (NIC) address resolution protocol (ARP) batching. A network interface controller (NIC) of host system, such as the network access subsystem 220 of the networked system 200, may provide batching services, using the batching module component 230 for example. The batching servicing may comprise receiving a network packet and buffering the received network packet within the network access subsystem 220, utilizing the networking memory 224 for example, to delay handling of the received network packet. The delaying may be performed based on a determination, via the batching module component 230, that the received network packet matches at least one criterion for allowing delayed handling of received network packets by the networked system 200. The delaying may also be performed based on a determination, via the batching module component 230, that the networked system 200, or a particular component thereof which is utilized during handling of the received network packet (e.g. host processor 202), may be in a power saving state. In this regard, handling of received network packets may require that the networked system 200, or the particular component, transition from the power saving state. Determining whether delayed handling of received network packets may be allowed may be based on type of the received network packet. For example, received network packet may comprise, for example, broadcast Address Resolution Protocol (ARP) packet. In this regard, delayed handling of the received network packet may be allowed when the received network packet is a broadcast ARP packet that is not directed to the networked system 200.

Network packets buffered in the network access subsystem 220 may be flushed, or forwarded to other components of the networked system 200, based on a plurality of packet flushing criteria. Exemplary flushing criteria may comprise a determination that an incoming network packet may require immediate handling in the networked system 200, an expiry of a buffering timer, reaching or exceeding a buffering threshold, which may be based on total number of buffered packets, and/or triggering a network packet transmission from the network access subsystem 220. Determining that the networked system 200, and/or the particular component thereof, is in a power saving state may be based on information communicated to the network access subsystem 220 or when one or more low power state transition presumption criteria is met. The low power state transition presumption criteria may comprise expiry of an inactivity timer that may be run in the network access subsystem 220, via the batching module component 230 for example. In this regard, the inactivity timer may be started after a transmission of network packet from the network access subsystem 220.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for network interface controller (NIC) address resolution protocol (ARP) batching.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method, comprising:
in a network interface controller:
receiving a network packet;
buffering said received network packet within said network interface controller;
determining when delayed handling of said received network packet by a host system associated with said network interface controller is permissible;
delaying forwarding of said received network packet to said host system based on said determination that delayed handling of said received network packet by said host system is permissible, wherein said delayed handling of said received network packet enables at least one component of said host system that is utilized during said handling of said received network packet to remain in a power saving state; and
forwarding said received network packet to said host system when at least one of a plurality of flushing criteria is met.

2. The method according to claim 1, wherein said at least one component of said host system is a processor.

3. The method according to claim 1, wherein said one or more flushing criteria comprise a determination that a subsequent received network packet requires immediate handling by said host system.

4. The method according to claim 3, wherein said subsequent received network packet requiring immediate handling comprises a unicast packet destined for said host system and/or a broadcast packet that requires a response from the host system.

5. The method according to claim 1, wherein said one or more flushing criteria comprise an expiry of a buffering timer, a determination that a total number of buffered network packets reaches or exceeds a maximum threshold, and/or receiving from said host system a request for network packet transmission.

6. The method according to claim 1, comprising determining when said delayed handling of said received network packets is permitted based on type of said received network packet.

7. The method according to claim 1, wherein said received network packet comprises a broadcast Address Resolution Protocol (ARP) packet that does not require a response from said host system.

8. The method according to claim 1, comprising delaying forwarding of network packets by said network interface controller based on presumption that a transition to said power saving state has occurred.

9. The method according to claim 8, wherein said presumption is based on expiry of a transmission inactivity timer.

10. The method according to claim 9, comprising starting said transmission inactivity timer after a last transmission associated with said host system.

11. The method according to claim 8, wherein said presumption is based on observation via said network interface controller that a Peripheral Component Interconnect Express (PCIE) interface utilized in forwarding network packets to said host system has transitioned to low power state, said low power state comprising a low power Active State Power Management (ASPM) state.

12. The method according to claim 8, wherein said presumption is based on reception via said network interface controller of an Optimized Buffer Flush/Fill (OBFF) message over a Peripheral Component Interconnect Express (PCIE) interface from said host system indicating that said host system is in a lower power state.

13. A system, comprising:
one or more circuits for use in a network interface controller, said one or more circuits being operable to:
receive a network packet;
buffer said received network packet within said network interface controller;
determine when delayed handling of said received network packet by a host system associated with said network interface controller is permissible;
delay forwarding of said received network packet to said host system based on said determination that delayed handling of said received network packet by said host system is permissible, wherein said delayed handling of said received network packet enables at least one component of said host system that is utilized during said handling of said received network packet to remain in a power saving state; and
forward said received network packet to said host system when at least one of a plurality of flushing criteria is met.

14. The system according to claim 13, wherein said at least one component of said host system is a processor.

15. The system according to claim 13, wherein said one or more flushing criteria comprise a determination that a subsequent received network packet requires immediate handling by said host system.

16. The system according to claim 15, wherein said subsequent received network packet requiring immediate handling comprises a unicast packet destined for said host system and/or a broadcast packet that requires a response from the host system.

17. The system according to claim 13, wherein said one or more flushing criteria comprise an expiry of a buffering timer, a determination that a total number of buffered network packets reaches or exceeds a maximum threshold, and/or receiving from said host system a request for network packet transmission.

18. The system according to claim 13, wherein said one or more circuits are operable to determine when said delayed handling of said received network packets is permitted based on type of said received network packet.

19. The system according to claim 13, wherein said received network packet comprises a broadcast Address Resolution Protocol (ARP) packet that does not require a response from said host system.

20. The system according to claim 13, wherein said one or more circuits are operable to delay forwarding of network packets from said network interface controller based on presumption that a transition to said power saving state has occurred.

21. The system according to claim 20, wherein said presumption is based on expiry of a transmission inactivity timer.

22. The system according to claim 21, comprising starting said transmission inactivity timer after a last transmission associated with said host system.

23. The system according to claim 20, wherein said presumption is based on observation via said network interface controller that a Peripheral Component Interconnect Express (PCIE) interface utilized in forwarding network packets to said host system has transitioned to low power state, said low power state comprising a low power Active State Power Management (ASPM) state.

24. The system according to claim 20, wherein said presumption is based on reception via said network interface controller of an Optimized Buffer Flush/Fill (OBFF) message over a Peripheral Component Interconnect Express (PCIE) interface from said host system indicating that said host system is in a lower power state.
